(19) United States
(12) Patent Application Publication
(10) Pub. No.: US 2025/0285473 A1
(43) Pub. Date: Sep. 11, 2025

(54) TRIGGERING OUTPUT OF A RE-TORQUE SIGNAL

(71) Applicant: NIRA Dynamics AB, Linköping (SE)

(72) Inventors: Olle Hynén Ulfsjöö, Linköping (SE); Rickard Karlsson, Linköping (SE)

(21) Appl. No.: 18/859,959

(22) PCT Filed: Apr. 25, 2023
(86) PCT No.: PCT/EP2023/060812

§ 371 Date: Oct. 24, 2024

(30) Foreign Application Priority Data
Apr. 25, 2022 (DE) 10 2022 109 921.0

(51) Int. Cl. G07C 5/00; G07C 5/04

(52) U.S. Cl. CPC G07C 5/006; G07C 5/04

(57) ABSTRACT

There is provided a method, a system and a computer program product for triggering output of a re-torque signal indicative of a recommendation to fasten bolts of at least one wheel. The method comprises receiving at least wheel speed signals of the at least one wheel of a vehicle, determining, on the basis of the wheel speed signals, first current wheel properties of the at least one wheel, retrieving, from a storage device, calibrated wheel properties of the at least one wheel determined over at least two calibration phases, the at least two calibration phases being separated by at least one first wheel change of the wheel and determining whether the wheel has undergone a second wheel change by comparing the first current wheel properties with the calibrated wheel properties of at least a latest calibration phase. In response to determining that the second wheel change of the wheel has occurred, the method comprises triggering output of the re-torque signal based on a predetermined distance and/or a predetermined time since the determined second wheel change.

### TECHNICAL FIELD

The present disclosure generally relates to the area of wheel changes of a vehicle, and particularly to methods, systems and computer program products for triggering output of a re-torque signal indicative of a recommendation to fasten bolts of at least one wheel of a vehicle.

### BACKGROUND OF THE INVENTION

Modern vehicles comprise a variety of sensors and systems to provide the driver and other traffic participants with safety, comfort and information.

These systems include vehicle driver safety information systems in relation to wheel or tire properties, such as loose wheel indicators and sensor-free tire pressure monitoring system, e.g. indirect Tire Pressure Monitoring Systems (iTPMS), which provide information about the driving condition to the driver. Further examples include direct Tire Pressure Monitoring Systems (dTPMS).

During the lifetime of a vehicle, one or more wheels or tires of the vehicle may eventually become damaged and need to be changed. Such changes may be regularly, e.g. periodically due to seasonal road conditions or due to abrasion or wear (typically concerning all wheels of the vehicle), or due to puncture of one particular flat tire. Not changing wheels or tires of a vehicle may jeopardize secure driving conditions for the driver and cause accidents. As a result, wheels or tires are changed repeatedly during the lifetime of a vehicle.

However, following any wheel change, it may be required to re-torque the changed wheel(s), for example, after the vehicle has been driven over a certain distance, in order to guarantee/maintain the vehicle's driving functionality and working conditions as well as to ensure traffic safety.

For current systems that do not exchange tire ID information, such as iTPMS systems where no tire ID may be available, the driver is required to ensure that the wheels are re-torqued at certain intervals after the wheel change, i.e., the driver must keep track and remember when the bolts of the wheel of the vehicle have to be fastened.

Manually keeping track of wheel changes is not only difficult, but also a potential source of accidents, e.g. when the driver forgets to re-torque the bolts of the wheels after a wheel change when required.

Thus, there is a need for systems that can automatically issue a recommendation/warning to the driver to re-torque the wheels of a vehicle after a wheel change before the wheels become (too) loose.

### OBJECT OF THE INVENTION

In order to overcome shortcoming of known approaches, particularly of the kind mentioned above, an object of the present invention is to trigger output of a re-torque signal indicative of a recommendation to fasten bolts of at least one wheel of the vehicle following a wheel change.

### SUMMARY OF THE INVENTION

In light of the above, methods, systems and computer program products are provided to achieve the mentioned objective. Further aspects, advantages, and features are apparent from the dependent claims, the description, and the accompanying drawings.

The subject-matter provided by the present invention is defined in the independent claims, while preferred embodiments of the present invention are defined in the dependent claims.

According to an embodiment, a method for triggering output of a re-torque signal indicative of a recommendation to fasten bolts of at least one wheel is provided. The method comprises:
receiving at least wheel speed signals of the at least one wheel of a vehicle;
determining, on the basis of the wheel speed signals, first current wheel properties of the at least one wheel;
retrieving, from a storage device, calibrated wheel properties of the at least one wheel determined over at least two calibration phases, the at least two calibration phases being separated by at least one first wheel change of the wheel;
determining whether the wheel has undergone a second wheel change by comparing the first current wheel properties with the calibrated wheel properties of at least a latest calibration phase; and
in response to determining that the second wheel change of the wheel has occurred:
triggering output of the re-torque signal based on a predetermined distance and/or a predetermined time since the determined second wheel change.

According to an embodiment, a system for triggering a re-torque signal to be outputted is provided, comprising a storage device configured to store calibrated wheel properties and a processing unit, the processing unit configured to carry out the steps of the above method.

According to an embodiment, a computer program product is provided comprising instructions which, when the program is executed by a computer, cause the computer to carry out the steps of the above method.

According to an embodiment, a computer-readable storage medium is provided, comprising instructions which, when executed by a computer, cause the computer to carry out the steps of the above method.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 schematically shows a framework or system of a re-torque reminder functionality according to embodiments;

FIG. 2A shows a flow diagram of a method according to embodiments;

FIG. 2B shows a flow diagram of another method according to embodiments.

### DETAILED DESCRIPTION

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure.

Further, features illustrated or described as part of one embodiment can be used on or in conjunction with other embodiments to yield yet a further embodiment. It is intended that the description includes such modifications and variations.

The drawings are schematic drawings which are not drawn to scale. Some elements in the drawings may have dimensions which are exaggerated for the purpose of highlighting aspects of the present disclosure and/or for the sake of clarity of presentation.

Embodiments herein relate generally to triggering output of a re-torque signal indicative of a recommendation to fasten the bolts of at least one wheel of a vehicle.

For example, during the lifetime of a vehicle, wheels or tires of the vehicle may need to be changed for various reasons, such as puncture or seasonal road conditions.

However, after a wheel change, the bolts typically become loose and are required to be re-torqued, e.g. after a certain time and/or driving distance.

In conventional systems, e.g. for systems in which no tire ID is available, re-torquing entirely depends on the driver, e.g. the driver has to remember when to fasten the bolts following a wheel change. Such reliance on the driver may be error-prone.

It is therefore beneficial to provide methods, systems, and computer program products that automatically trigger output of a re-torque signal indicative of a recommendation to fasten bolts of at least one wheel of a vehicle, e.g. following a wheel change.

Throughout the disclosure, the terms “wheel” and “tire” may be used interchangeably and may include/refer to both a rim as well as the ring-shaped component, e.g. made from rubber, surrounding it. In other words, the “wheel” as a whole is meant.

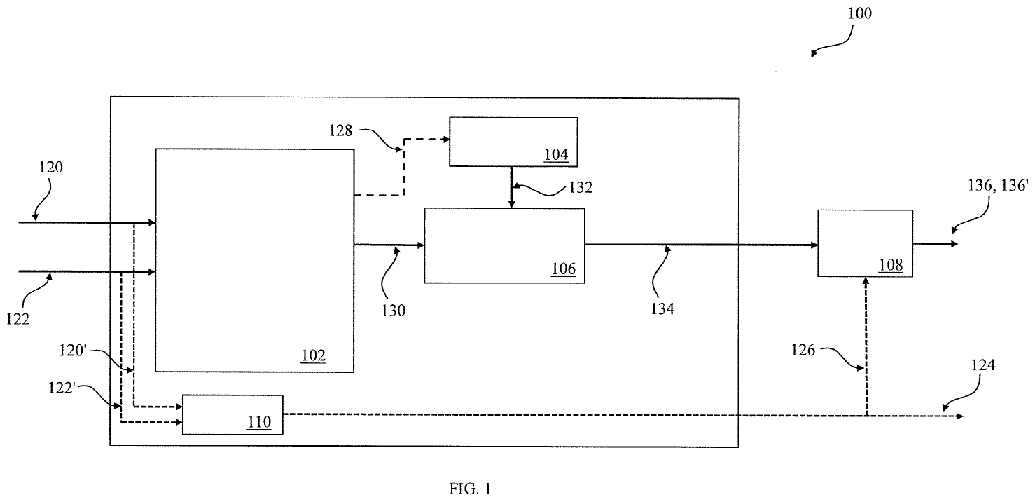

FIG. 1 shows an exemplary framework or system 100 that implements a re-torque reminder functionality according to one embodiment.

The system 100 may include a tire pressure monitoring system 102, a storage device 104, a tire change detector (TCD) 106 and a re-torque reminder 108. The system 100 may also comprise one or more processing devices (not shown).

The tire pressure monitoring system 102 may be, for example, an indirect Tire Pressure Monitoring Systems (iTPMS) or a direct Tire Pressure Monitoring Systems (dTPMS).

For iTPMS systems or data, no tire ID is available or exchanged so that the driver is required to manually check/remember when to re-torque the wheel following the wheel change. Thus, for iTPMS systems, there is a need for an automatic re-torque signal functionality and the present invention is particularly useful in such cases.

However, instead of iTPMS systems/data, it should be noted that the present invention is also compatible and/or beneficial when used in connection with a direct Tire Pressure Monitoring Systems (dTPMS) and dTPMS data, for which a tire ID is generally available.

With reference to FIG. 1, it should be understood that although certain elements/entities are depicted as being apart/separated from each other (for example the storage device 104 is illustrated as being separate from the TCD 106 and/or the re-torque reminder 108) that the storage device 104 may also be located/included within the loose wheel detector 110, the re-torque reminder 108, the tire change detector 106 and/or tire pressure monitoring system 102. The same applies to the one or more processing units (not shown).

The system 100 shown in FIG. 1 may optionally also include a loose wheel detector 110 by which, among other things, additional information about the status of the wheel's bolts may be obtained and used in combination with the output of a re-torque signal.

Using a loose wheel detector 110 in the system 100 may allow, inter alia, to expedite output/triggering of a re-torque signal, e.g. in cases where bolts become loose earlier than expected. For example, in cases when the vehicle has not yet completed a predetermined distance and/or time since the detected wheel change.

Consequently, optional usage of a loose wheel detector 110 in combination with a tire pressure monitoring system 102, a tire change detector 106 and a re-torque reminder 108 may ensure even further safety and/or enhance performance of the re-torque reminder functionality.

According to embodiments, one or more signals 120, 122 may be provided to or input at the tire pressure monitoring system 102. Additionally or alternatively, the signals 120, 122 may also be provided to or received at the loose wheel detector 110, which is indicated by the dashed arrows 120′, 122′ shown in FIG. 1. It should be understood that signals 120, 122 are generally identical to signals 120′, 122′, but the latter are only forwarded to a different system entity/element, namely the loose wheel detector 110.

The signals 120, 122 may include wheel speed signals 120 (120′) of at least one wheel of the vehicle indicative of the wheel speed of the vehicle. The signals 120, 122 may also include timestamped sensor data, e.g. Controller Area Network (CAN)-signals 122 (122′) and or protocol records.

Generally, at least wheel speed signals 120 are to be received in order to enable re-torque reminder functionality. According to embodiments, CAN signals 122 may be received in addition to or in connection with wheel speed signals 120.

According to embodiments, on the basis of the received signals 120, 122, first current wheel properties of at least one wheel of the vehicle may be determined.

The first current wheel properties may include physical parameters or values related to the wheel of the vehicle that can be measured/determined, e.g. using the tire pressure monitoring systems 102 (direct or indirect).

In particular, these may include properties determined by an indirect tire pressure monitoring system, such as tire vibration frequency, slip slope, relative tire radii, absolute tire radii, vibration energy, Fourier Transform, e.g. Fast Fourier Transform, properties.

Additionally or alternatively, these may include GPS signals for roll radius estimation, GPS time-stamp info or the like.

Additionally or alternatively, these may include finger printing of the at least one wheel using machine learning methods on the wheel speed signals.

“Finger printing” may be understood as identifying a wheel by using artificial intelligence and/or machine learning to determine unique and individual wheel characteristics for the wheel, such as size, shape, profile (shape and depth) and the like, e.g. based on visual inspection. Finger printing may be used to track and trace wheels, e.g. from the time of manufacturing to the time of sale.

The first current wheel properties may be stored in a storage device 104 for later use, e.g. after they have been determined. This is indicated by the dashed arrow 128 illustrated in FIG. 1.

Once the first current wheel properties are stored (s. dashed arrow 128 of FIG. 1), they may be referred to as “calibrated wheel properties”. For example, wheel properties stored in the storage device 104 may be referred to “calibrated wheel properties”.

Current wheel properties may be stored for one or more calibration phases. In particular, first current wheel properties may be determined over the span of one calibration phase, i.e. until one calibration phase is completed. Then, the next calibration phase may begin in which further/another first current wheel properties are determined.

Calibrated wheel properties may be stored for at least two calibration phases. Doing so may enable to compare if the tire has been changed. For example, having at least two calibration phases may enable to compare the wheel properties across the different calibration phases in order to determine if the tire has been changed. At least two calibration phases may be necessary for the algorithm to work. Comparing the wheel properties may allow to (e.g. accurately and reliably) determine if the tire has been changed.

A calibration phase may be understood as a particular (e.g. pre-defined or adjustable) time interval, in which current wheel properties of at least one wheel of the vehicle may be determined. Likewise, a calibration phase may also be understood as a particular (e.g. pre-defined or adjustable) distance (e.g. travelled by the vehicle) in which current wheel properties of at least one wheel of the vehicle may be determined. Also, a combination of both may be used.

Generally, in a first calibration phase, first current wheel properties are determined and in a second calibration phase, second current wheel properties are determined. Thus, the term “current” used in relation to the wheel properties merely indicates that these are wheel properties that are currently measured, e.g. during a current calibration phase.

For example, when the vehicle is in a first calibration phase where first wheel properties are being determined and no first wheel change has occurred yet (i.e. no reset of the first calibration phase), the first wheel properties correspond to the current wheel properties. As can be readily understood, the same applies for the second, third etc. calibration phases and wheel properties.

Once the current wheel properties are determined, e.g. using the tire pressure monitoring systems 102 (direct or indirect), the same may be provided or forwarded to the tire change detector 106 as indicated by the arrow 130 of FIG. 1.

The at least two calibration phases may be separated by at least one (e.g. a first) wheel change of the wheel of the vehicle.

For example, during a first calibration phase, e.g. before a first wheel change, first current wheel properties of the at least one wheel of the vehicle are determined by the tire monitoring system 102 on the basis of signals 120, 122.

After a certain time, a first wheel change of the at least one wheel of the vehicle occurs. This may stop or terminate the first calibration phase and/or determination of first current wheel properties (if not already occurred) and cause storing 128 of the first current wheel properties at/in the storage device 104 as first calibrated wheel properties.

At the same time, the wheel change may initiate start of a second (new) calibration phase, during which another first wheel properties are determined by the tire monitoring system 102 on the basis of signals 120, 122. Likewise, these may be eventually also stored 128 at the storage device 104 as (additional) calibrated first wheel properties—i.e. these may be stored in addition to the calibrated wheel properties determined/stored in/for the first calibration phase.

To this end, the first wheel change may also be regarded as a trigger or a reset, e.g. to end a previous calibration phase (e.g. a first calibration phase), if it has not ended yet, and to start/initiate a new calibration phase (e.g. a second calibration phase).

It should be noted that the vehicle may not be required to be driving in the first and/or second calibration phase. This may be due to the fact that either a predetermined distance, e.g. when the vehicle is driving, or a predetermined time, e.g. when the vehicle is not driving, or a combination, may be used.

The number of wheel changes is not limited and may include any suitable number that may conform to the lifetime of the particular wheel. Also, it may be adjustable. The first wheel change may refer to an absolute first wheel change of the wheel, i.e. after a new wheel has been purchased/manufactured, or a first wheel change of wheel that has already been used before, e.g. for seasonal summer/winter tires. The first wheel change may serve as a reference to start the first calibration phase.

According to embodiments, after a first or current calibration phase, a second or new calibration phase may be initiated, e.g. after it has been determined that a wheel change has occurred. Upon initiation of the new calibration phase, determination of first wheel properties, i.e. first current wheel properties, in the current calibration phase may stop and the first current wheel properties may be stored 128 in the storage device 104 as calibrated wheel properties of the at least one wheel. Thereafter, determination of new current wheel properties, i.e. first wheel properties of the new calibration phase after the wheel change may start.

The system 100 and/or any of its components 102, 104, 106, 108 or 110 may also include logic to clear or erase at least some of the calibrated wheel properties stored in storage device 104. This may be used to avoid a potential loop.

For example, if the re-torque reminder functionality is triggered erroneously and/or repeatedly, it is possible to remove the same by clearing or erasing one or more of the calibrated wheel properties.

For example, it may be beneficial to clear at least some wheel properties due to changed circumstances, e.g. after maintenance/reparations when wheel properties are changed. Clearing wheel properties may occur selectively or for a group of properties. Also, the entire calibration, e.g. all properties may be cleared instead of specific ones. This may further enhance accuracy, reliability and/or performance of the re-torque reminder functionality.

The first and/or the second calibration phase may be in the range of 30 to 60 minutes while driving in varied speeds between 40 and 120 km/h. Although the calibration is mainly time-based, it may also be distance-based using typically distances between 20 and 120 km for the first and/or the second calibration phase.

According to embodiments, it may be determined whether the wheel has undergone a second wheel change. This can be done, for example, by the tire change detector 106, by comparing the first current wheel properties with the calibrated wheel properties of one or more other or previous calibration phases. According to embodiments, at least a latest calibration phase may be used for the comparison. The “latest calibration phase” may refer to the most recent determination of first wheel properties, i.e. the most up-to-date values.

For example, the tire change detector 106 may receive 130 first current wheel properties. Also, the tire change detector 106 may receive 132 calibrated wheel properties stored in the storage device 104 for one or more calibration phases. The tire change detector 106 may then compare the first current wheel properties with the calibrated wheel properties of one or more calibration phases to determine that the wheel change has occurred. The result of the comparison may be forwarded 134 to the re-torque reminder 108.

However, it should be understood that the comparing step may also be carried out, for example, using the tire pressure monitoring system 102, the re-torque reminder 108 and/or the loose wheel detector 110, e.g. either alone or in combination.

According to embodiments, the determination whether the wheel change (e.g. the second wheel change) has occurred may be based on a deviation between the first current wheel properties and the calibrated wheel properties that have been stored during one or more calibration phases, e.g. using at least the calibrated wheel properties determined in the latest calibration cycle. The deviation may be compared to a predetermined range or ratio of the wheel properties (which may be individually adjustable).

For example, a deviation between the tire vibration frequency (e.g. exemplary first wheel properties measured in Hertz, Hz) may serve as an indicator when a wheel change has occurred.

In such examples, the current vibration frequency of the at least one wheel of the vehicle may be determined, e.g. using the iTPMS 102, during a current calibration phase and compared with a calibrated tire vibration frequency, e.g. determined by the iTPMS 102 in one or more previous calibration phases (or at least the one determined in the latest calibration phase) and stored at storage device 104.

As a result, a deviation (or ratio) between the current and the calibrated tire vibration frequency may be obtained.

A threshold or condition, e.g. a minimal value for the deviation and a maximal value for the deviation may be defined, in order to specify whether the determined deviation classifies as a wheel change (e.g. when the deviation is inside the threshold values) or not (e.g. when the deviation is outside the threshold values).

In the example of using vibration frequency, a threshold for the deviation may be in the range of 1-10%. It should be noted that the upper limit may also be above 10%, i.e. depending on the wheel properties that are used.

In response to determining that the second wheel change of the wheel has occurred, an output of a “signal” may be triggered. The outputted signal 136 is illustrated in FIG. 1 and it may be outputted by the re-torque reminder 108.

The “signal” includes for example a notification, a reminder and/or a recommendation which is presented to the driver of a vehicle to indicated that the bolts of the at least one wheel require fastening. In other words, the signal may serve as a reminder and/or recommendation for a driver to re-torque the at least one wheel of the vehicle.

According to embodiments, the output of the re-torque signal may be triggered based on a predetermined distance and/or a predetermined time since the determined wheel change, e.g. since the determined second wheel change.

Also, the re-torque signal may be actually outputted in response to determining that the vehicle has been driven over the predetermined distance and/or the predetermined time since the determined second wheel change.

According to embodiments, the predetermined distance since the determined (e.g. the second) wheel change may be in the range of 1-250 km or even above 250 km, particularly 1-150 km, more particularly 50-100 km. The predetermined distance may be in a range around 50 km, i.e. 25-75 km. Additionally or alternatively, the predetermined time since the determined (e.g. the second) wheel change is in the range of 1-4 weeks, particularly 1-2 weeks, and/or a couple of days, e.g. 2-6 days, in which, e.g., the vehicle is driving/driven. In such cases, GPS information may additionally be used.

According to embodiments, second current wheel properties of at least one wheel of the vehicle may be determined.

The second current wheel properties may be different from the first current wheel properties. The second current wheel properties may be determined based on at least the received wheel speed signals 120. CAN signals 122 may also be used in the determination of second current wheel properties.

With reference to FIG. 1, second current wheel properties may be determined using the optional loose wheel detector 110 to which the wheel speed signals 120′ and the CAN signals 122′ may be forwarded.

On the basis of the second current wheel properties, it may be determined that the at least one wheel of the vehicle is a loose wheel. Also, information about the wheel may be obtained therefrom, such as information about the status of the wheel's bolts. For example, the status of the wheel's bolts may correspond to completely fastened or loose.

As shown in FIG. 1, the second current wheel properties determined by the loose wheel detector 110 may either be outputted 124 directly, e.g. to indicate that the at least one wheel of the vehicle has become loose, or it may be provided 126 to the re-torque reminder 108 for further use. The latter further enhances the overall re-torque reminder functionality by allowing/enabling to inform the driver that bolts of the wheel have become loose sooner than expected (s. details below).

On the basis of information from the loose wheel detector 110, e.g. information about the status of the wheel's bolts, a preceding re-torque signal 136′ may be outputted by the re-torque reminder 108.

A “preceding re-torque signal” may be understood in a signal that is triggered and/or outputted timely before the actual re-torque signal 136, i.e. based on the comparison (e.g. by the tire change detector 106) between the first current wheel properties determined by the tire pressure monitoring system 102 with the calibrated wheel properties stored 128 in the storage device 104.

In other words, the “preceding re-torque signal” 136′ may be outputted in conjunction with determination of second current wheel properties and usage of a loose wheel detector 110 while the (actual) re-torque signal 136 may be outputted in conjunction with determination of first wheel properties and usage of the tire change detector 106.

It should be understood that the re-torque signal 136 may also be outputted even if a timely preceding re-torque signal 136′ has been outputted, as this ensures further safety as well as enhances performance and re-torque reminder functionality.

The preceding re-torque signal 136′ may, for example, be used in cases where the bolts of at least one wheel become loose earlier than expected, i.e. before the predetermined distance and/or before the predetermined time mentioned herein.

The preceding re-torque signal may be outputted based on estimating a time (for example 1-2 weeks since the wheel change) and/or distance (for example 50-100 km since the wheel change) for an upcoming re-torque of the wheel, e.g. where the wheel's bolts are expected to become loose. When a loose wheel detector 110 is used, it can determine whether the at least one wheel is a loose wheel. This may occur on the basis of wheels speed signals of the wheel indicative of the wheel speed of the vehicle. It should be noted that the loose wheel detector 110 does not require data from at least two calibration phases, i.e. it does not utilize calibration. Rather, it is able to detector whether the at least one wheel is a loose wheel without storing and comparing different wheel properties.

In response to determining that the at least one wheel is a loose wheel, the preceding re-torque signal 136′ may be outputted. Since the output of the preceding re-torque signal 136′ may be timely before the actual re-torque signal 136, the preceding re-torque signal 136′ may expedite issuance of re-torque necessity of the bolts of the at least one wheel, e.g. in cases where the bolts of the wheel become loose sooner than expected.

The re-torque signal 136 and/or the preceding re-torque signal 136′ may serve as an (automatic) indication, notification and/or recommendation for the driver of the vehicle to re-torque the bolts of the at least one wheel after the determined (e.g. the second) wheel change.

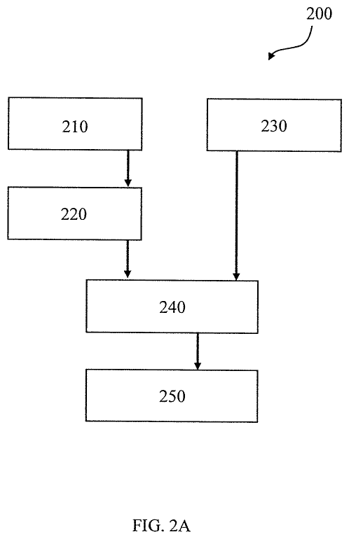

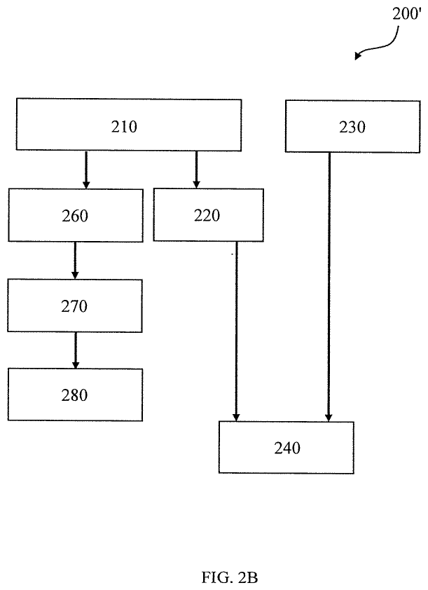

FIG. 2A illustrates a flow diagram of a method 200 for triggering output of a re-torque signal 136 indicative of a recommendation to fasten bolts of at least one wheel according to embodiments.

At step 210, the wheel speed signals 120 and/or CAN signals 122 of the at least one wheel of the vehicle may be received, e.g. at the tire pressure monitoring system 102. At step 220, first current wheel properties of the at least one wheel are determined on the basis of at least the wheel speed signals 120 and forwarded 130 to the tire change detector 106. In step 230, calibrated wheel properties of the at least one wheel determined over at least two calibration phases are retrieved 132 from a storage device 104, the at least two calibration phases being separated by at least one first wheel change of the wheel. In step 240, it is determined, e.g. at the tire change detector 106, whether the wheel has undergone a second wheel change by comparing the first current wheel properties with the calibrated wheel properties of at least a latest calibration phase. The result may be forwarded 134 to the re-torque reminder. In response 250, output of the re-torque signal 136 is triggered based on a predetermined distance and/or a predetermined time since the determined second wheel change. The re-torque signal 136 may then be outputted by the re-torque reminder, e.g. at a user interface of the vehicle.

FIG. 2B illustrates a flow diagram of another method 200′ for triggering output of a re-torque signal 136 in connection with a preceding re-torque signal 136′. Thus, FIG. 2B relates to an embodiment which optionally uses functionality of a loose wheel detector 110.

To this end, the method shown in FIG. 2B corresponds to the method shown in FIG. 2A except that an additional loose wheel detector 110 is used. In particular, steps 210-240 of the method 200 correspond to the steps 210-240 of the method 200′ shown in FIG. 2B.

At step 260, second current wheel properties of the at least one wheel are determined by the loose wheel detector 110 based on at least the received wheel speed signals 120′. CAN signals 122′ may also be used therefore. On the basis of the second current wheel properties, it is determined at step 270 that the at least one wheel is a loose wheel in order to obtain information about a status of the wheel's bolts. If this is the case, the method 200′ proceeds to step 280 and outputs a preceding re-torque signal 136′ before the (actual) re-torque signal 136. The preceding re-torque signal 136′ may then be outputted by the re-torque reminder 108, e.g. at a user interface of the vehicle.

While the foregoing is directed to embodiments of the disclosure, other and further embodiments of the disclosure may be devised without departing from the basic scope thereof, and the scope thereof is determined by the claims that follow.

What is claimed is:

1. A method for triggering output of a re-torque signal indicative of a recommendation to fasten bolts of at least one wheel, the method comprising:
receiving at least wheel speed signals of the at least one wheel of a vehicle;
determining, on the basis of the wheel speed signals, first current wheel properties of the at least one wheel;
retrieving, from a storage device, calibrated wheel properties of the at least one wheel determined over at least two calibration phases, the at least two calibration phases being separated by at least one first wheel change of the wheel;
determining whether the wheel has undergone a second wheel change by comparing the first current wheel properties with the calibrated wheel properties of at least a latest calibration phase; and
in response to determining that the second wheel change of the wheel has occurred:
triggering output of the re-torque signal based on a predetermined distance and/or a predetermined time since the determined second wheel change.

2. A method according to claim 1, further comprising:
receiving timestamped sensor data such as controller area network, CAN, signals in connection with the wheel speed signals.

3. A method according to claim 1, wherein determining whether the second wheel change has occurred is based on a deviation between the first current wheel properties and the calibrated wheel properties, wherein the deviation is a range or ratio that is adjustable.

4. A method according to claim 1, further comprising:
initiating a new calibration phase after determining that the second wheel change has occurred by
stopping determination of the first current wheel properties of the at least one wheel in a current calibration phase;
storing the first current wheel properties for the current calibration phase as calibrated wheel properties of the at least one wheel in the storage device; and
starting determination of new current wheel properties in the new calibration phase after the second wheel change.

5. A method according to claim 4, further comprising:
clear at least some of the stored calibrated wheel properties.

6. A method according to claim 1, wherein the re-torque signal is outputted in response to determining that the vehicle has been driven over the predetermined distance and/or the predetermined time since the determined second wheel change.

7. A method according to claim 6, wherein
the predetermined distance since the determined second wheel change is in the range of 1-250 km, particularly in the range of 1-150 km, more particularly in the range of 50-100 km; and/or
the predetermined time since the determined second wheel change is in the range of 1-4 weeks, particularly in the range of 1-2 weeks.

8. A method according to claim 1, wherein the first current wheel properties of the at least one wheel comprises:
properties determined by an indirect tire pressure monitoring system, such as tire vibration frequency, slip slope, relative and/or absolute tire radii, vibration energy, Fourier Transform properties; and/or
GPS signals for roll radius estimation, GPS time-stamp info; and/or
finger printing of the at least one wheel using machine learning on the wheel speed signals.

9. A method according to claim 1, further comprising:
determining second current wheel properties of the at least one wheel, based on at least the received wheel speed signals;
determine, on the basis of the second current wheel properties, that the at least one wheel is a loose wheel in order to obtain information about a status of the wheel's bolts; and
on the basis of the information about the status of the wheel's bolts:
outputting a preceding re-torque signal before the re-torque signal.

10. A method according to claim 9, wherein the second current wheel properties of the at least one wheel are based on the received wheel speed signal.

11. A method according to claim 9, wherein the preceding re-torque signal is outputted based on
estimating a time and/or distance for an upcoming re-torque where the wheels bolts are expected to be loose;
determining whether the at least one wheel is a loose wheel;
outputting, in response to determining that the at least one wheel is a loose wheel, the preceding re-torque signal to expedite issuance of re-torque necessity of the bolts of the at least one wheel.

12. A method according to claim 9, wherein the re-torque signal and the preceding re-torque signal serve as an indication for a driver of the vehicle to re-torque the bolts of the at least one wheel after the determined second wheel change.

13. A system for triggering a re-torque signal to be outputted, comprising:
a storage device configured to store calibrated wheel properties and comprising a processing unit,
wherein the processing unit is configured to perform steps including:
receiving at least wheel speed signals of the at least one wheel of a vehicle;
determining, on the basis of the wheel speed signals, first current wheel properties of the at least one wheel;
retrieving, from a storage device, calibrated wheel properties of the at least one wheel determined over at least two calibration phases, the at least two calibration phases being separated by at least one first wheel change of the wheel;
determining whether the wheel has undergone a second wheel change by comparing the first current wheel properties with the calibrated wheel properties of at least a latest calibration phase; and
in response to determining that the second wheel change of the wheel has occurred:
triggering output of the re-torque signal based on a predetermined distance and/or a predetermined time since the determined second wheel change.

14. (canceled)

15. A computer-readable storage medium comprising instructions which, when executed by a computer, cause the computer to carry out steps that comprise:
receiving at least wheel speed signals of the at least one wheel of a vehicle;
determining, on the basis of the wheel speed signals, first current wheel properties of the at least one wheel;
retrieving, from a storage device, calibrated wheel properties of the at least one wheel determined over at least two calibration phases, the at least two calibration phases being separated by at least one first wheel change of the wheel;
determining whether the wheel has undergone a second wheel change by comparing the first current wheel properties with the calibrated wheel properties of at least a latest calibration phase; and
in response to determining that the second wheel change of the wheel has occurred:
triggering output of the re-torque signal based on a predetermined distance and/or a predetermined time since the determined second wheel change.

16. The computer-readable storage medium of claim 15, wherein the computer-readable storage medium includes a computer program product including the instructions.
